(19) United States
(12) Patent Application Publication
(10) Pub. No.: US 2025/0303452 A1
(43) Pub. Date: Oct. 2, 2025

(54) SWING-TYPE SPRAY CLEANING GUN AND ITS SPRAYER

(71) Applicant: Whirlwind Tools Co., Ltd., NEW TAIPEI CITY (TW)

(72) Inventor: Hung-Fu LIANG, Keelung City (TW)

(21) Appl. No.: 19/053,933

(22) Filed: Feb. 14, 2025

(30) Foreign Application Priority Data
Apr. 2, 2024 (TW) 113203286

(51) Int. Cl. B08B 3/02; B05B 7/24; B08B 5/02

(52) U.S. Cl. CPC B08B 3/026; B05B 7/2429; B08B 5/02; B08B 2203/02

(57) ABSTRACT

A swing-type spray cleaning gun includes a gas supplier and a sprinkler. The sprinkler includes an adapter pipe assembly fixed to the gas supplier, a fixed outer pipe fixedly connected to the adapter pipe assembly, a spray pipe and a swing amplitude adjustment assembly. The fixed outer pipe has a stroke limiting hole. The spray pipe includes an elastic pipe body fixed to the adapter pipe assembly, a plurality of weight blocks in the pipe set inside the fixed outer pipe and fixed on the elastic pipe body, and an end weight block. The elastic pipe body extends to the outside of the fixed outer pipe. The end weight block is sleeved and mounted outside the fixed outer pipe and fixed on the elastic pipe body. The swing amplitude adjustment assembly is movably mounted on the spray pipe to selectively adjust the swing amplitude of the spray pipe.

### CROSS-REFERENCE TO RELATED APPLICATIONS

This application claims the priority benefit of Taiwan application serial No. 113203286, filed on Apr. 2, 2024. The entirety of the above-mentioned patent application is hereby incorporated by reference herein and made a part of the specification.

### BACKGROUND OF THE INVENTION

### (1) Field of the Invention

The present invention relates to a swing-type spray cleaning gun and a sprinkler, and in particular to a swing-type spray cleaning gun and a sprayer with adjustable swing amplitude.

### (2) Description of the Prior Art

Generally speaking, in some places with a lot of dust or debris, high-pressure air guns are usually used to spray clean the area to be cleaned, such as factories, car maintenance shops or car washes, etc. Although the cleaning effect of the air gun is very good, the traditional air gun can only focus on one point, and, when the area to be cleaned is large, the user needs to spend a lot of effort to sweep the entire area one by one, which is very laborious and time consuming.

In order to increase the cleaning efficiency of the air gun, the existing technology provides an air gun with a built-in hose, which can expand the spray range by swinging the hose during the spray. However, due to its swing mode, it is relatively unstable, and it is easy to create dead spots and unable to clean properly, which is very inconvenient. To this end, some industry players have developed a sprinkler with a counterweight at the outlet end of the hose, hoping that the presence of the counterweight will allow the hose to generate a more stable centrifugal force when spraying, and thus have a more uniform spray effect. However, due to the presence of the counterweight, the center of gravity of the hose is concentrated at the outlet end, and, when the pressure of the gas does not match the center of gravity of the hose, it is easy to cause random shaking.

### SUMMARY OF THE INVENTION

In view of the fact that in the prior art, although the existing air gun can reach a large area of spray area through a hose, it is easy to produce dead spots due to the uneven swing of the hose, resulting in inaccurate cleaning. Although the method of setting a counterweight at the outlet end of the hose can increase the centrifugal force at the outlet end of the hose, it can easily cause the hose to swing around due to the mismatch between the gas pressure and the center of gravity, causing trouble to the user. Therefore, the main purpose of this invention is to provide a swing-type spray cleaning gun and a sprinkler that can stably provide a larger spray range, thereby improving the cleaning effect.

In order to solve the problems of the prior art, the necessary technical means used in this invention is to provide a swing-type spray cleaning gun, which includes a gas supplier, a sprinkler, a spray pipe and a swing amplitude adjustment assembly.

The gas supplier is used to provide high-pressure gas. The sprinkler includes an adapter pipe assembly and a fixed outer pipe. The adapter pipe assembly is fixedly connected to the gas supplier and connected to one of the gas supply pipelines of the gas supplier. The fixed outer pipe is fixedly connected to the adapter pipe assembly, connected to the air supply pipeline, and has a stroke limiting hole extending along a telescopic direction.

The spray pipe includes an elastic pipe body, a plurality of weight blocks inside the pipe and an end weight block. The elastic pipe body has an assembly end and a spray end arranged oppositely, the assembly end is fixed to the adapter pipe assembly in the fixed outer pipe and connected to the air supply pipeline, the spray end extends from the assembly end to an open end of the fixed outer pipe.

A plurality of weight blocks inside the pipe are spaced apart from each other in the fixed outer pipe and fixed to the elastic pipe body, and adjacent to the assembly end, and each of the weight blocks inside the pipe has a first weight.

The end weight block is sleeved and mounted outside the open end and fixed on the elastic pipe body, and is adjacent to the spray end, and the end weight block has a second weight greater than the first weight.

The swing amplitude adjustment assembly includes a swing amplitude adjustment pipe and a locking piece. The swing adjustment pipe is movably arranged in the fixed outer pipe along the telescopic direction and is sleeved on the sprinkler. The locking piece is movably inserted into the stroke limiting hole along the telescopic direction to selectively fix the position of the swing adjustment pipe in the fixed outer pipe to adjust the swing amplitude of the spray pipe.

In one of the subsidiary technical means derived from the above necessary technical means, the spray pipe further includes a buffer weight block.

The buffer weight block is sleeved and fixed on the elastic tube body, and is located between one of the inner weight blocks adjacent to the spray end and the end weight block, and, the buffer weight block has a third weight, which is greater than the first weight and less than the second weight. Preferably, the weight blocks in each pipe has a first center of gravity, the end weight block has a second center of gravity, and the buffer weight block has a third center of gravity. The first centers of gravity have a first distance from each other, and the third center of gravity has a second distance from the first center of gravity of one of the pipe weight blocks adjacent to the spray end. There is a third distance between the second center of gravity and the third center of weight. The second distance is greater than the third distance and smaller than the first distance.

In one of the subsidiary technical means derived from the above necessary technical means, the adapter pipe assembly includes an outer pipe assembly and a hose assembly.

The outer pipe assembly has a first assembly end portion and a second assembly end portion that are connected to each other. The first assembly end portion has an outer thread and an inner thread oppositely arranged, and the fixed outer pipe is screwed to the outer thread. The second assembly end portion is fixed to the gas supplier and connected to the gas supply pipeline. The hose assembly is screwed to the inner thread, connected to the second assembly end portion, and has an extended pipe body. The elastic pipe body is sleeved and fixed to the extension pipe body, and is connected to the gas supply pipeline through the outer pipe assembly and the hose assembly.

In one of the subsidiary technical means derived from the above necessary technical means, the adapter pipe assembly includes an outer pipe assembly, a hose assembly and a supplier assembly.

The outer pipe assembly has a first assembly end portion and a second assembly end portion that are connected to each other. The first assembly end portion has an outer thread and an inner thread oppositely arranged, and the fixed outer pipe is screwed to the outer thread. The outer pipe assembly further has an additional assembly hole between the first assembly end portion and the second assembly end portion, and the additional assembly hole is used to assemble a liquid supply module. The hose assembly is screwed to the inner thread, connected to the second assembly end portion, and has an extended pipe body. The elastic pipe body is sleeved and fixed to the extension pipe body, and is connected to the gas supply pipeline through the outer pipe assembly and the hose assembly. The supplier assembly is assembled to the second assembly end portion and is used to be assembled to the gas supplier, so that the outer pipe assembly is connected to the gas supply pipeline.

In one of the subsidiary technical means derived from the above necessary technical means, the sprinkler further includes an outer pipe position adjustment ring. The outer pipe position adjustment ring is movably assembled to the adapter pipe assembly along the telescopic direction and is located between the adapter pipe assembly and the fixed outer pipe to adjust the position where the fixed outer pipe is fixed to the adapter pipe assembly.

As mentioned in the above, since the invention is provided with a plurality of in-pipe weight blocks at the assembly end of the elastic pipe body, an end weight block is provided at the spray end, and the weight of the end weight block is greater than the weight of the weight blocks inside the pipe. Therefore, when the spray pipe swings due to the passage of high-pressure gas, the weight blocks inside the pipe can provide a smaller centrifugal force, while the end weight block can provide a larger centrifugal force, thereby allowing the entire spray pipe to swing around evenly and stably due to changes in the center of gravity.

The specific embodiments used in the present invention will be further explained through the following embodiments and drawings.

### BRIEF DESCRIPTION OF THE DRAWINGS

The present invention will now be specified with reference to its preferred embodiment illustrated in the drawings, in which:

FIG. 1 illustrates a three-dimensional schematic diagram of the sprinkler provided by the first preferred embodiment of the present invention;

FIG. 2 is a three-dimensional exploded schematic diagram illustrating the sprinkler provided by the first preferred embodiment of the present invention;

FIG. 3 is a schematic diagram of the A-A section of the FIG. 1;

FIG. 4 is a schematic diagram of the B-B section of the FIG. 1;

FIG. 5 is a schematic cross-sectional view illustrating the swing adjustment pipe moving to the minimum limit position in the first preferred embodiment of the present invention;

FIG. 6 is a three-dimensional schematic diagram illustrating the swing-type spray cleaning gun provided by the second preferred embodiment of the present invention;

FIG. 7 is a schematic diagram of the C-C section of the FIG. 6;

FIG. 8 is a schematic cross-sectional view to illustrate the sprinkler provided by the second preferred embodiment of the present invention adjusts the position of the fixed outer pipe by changing the position of the outer pipe position adjustment ring;

FIG. 9 is a partially enlarged diagram of the FIG. 8;

FIG. 10 is a schematic three-dimensional view of the swing-type spray cleaning gun provided by the second preferred embodiment of the present invention;

FIG. 11 is a three-dimensional schematic diagram illustrating the swing-type spray cleaning gun provided by the third preferred embodiment of the present invention;

FIG. 12 is a schematic diagram of the D-D section of the FIG. 11;

FIG. 13 is a three-dimensional schematic diagram illustrating the swing-type spray cleaning gun provided by the fourth preferred embodiment of the present invention;

FIG. 14 is a schematic diagram of the E-E section of FIG. 13;

FIG. 15 is a three-dimensional schematic diagram illustrating the swing-type spray cleaning gun provided by the fifth preferred embodiment of the present invention; and

FIG. 16 is a schematic diagram of the F-F section in FIG. 15.

### DESCRIPTION OF THE PREFERRED EMBODIMENT

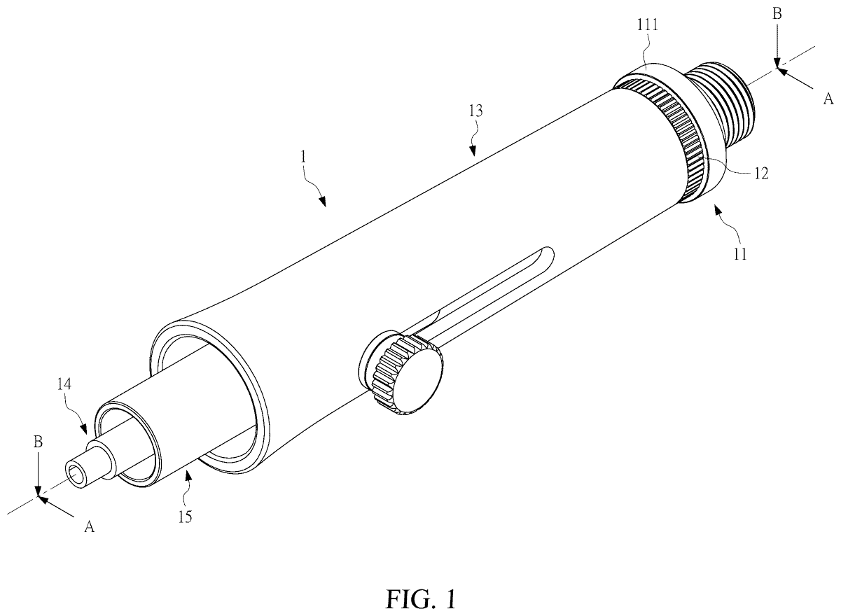

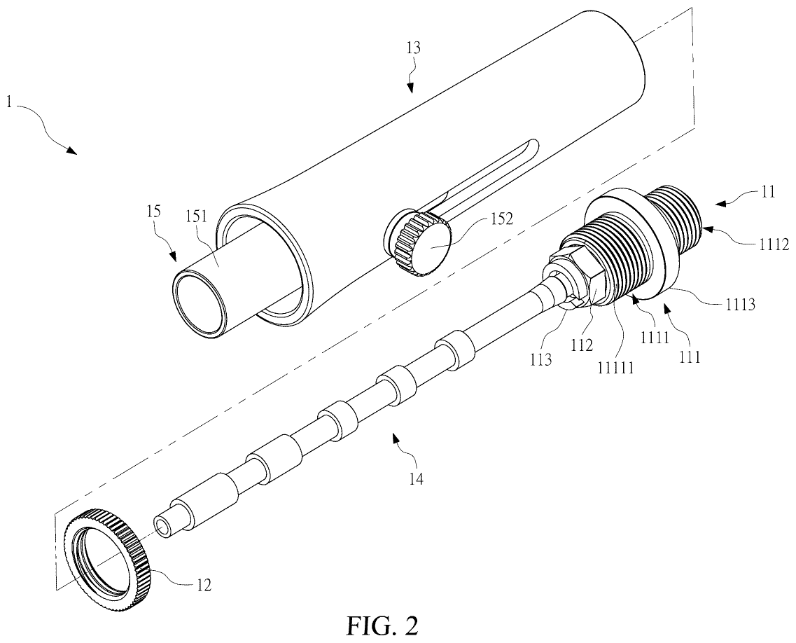

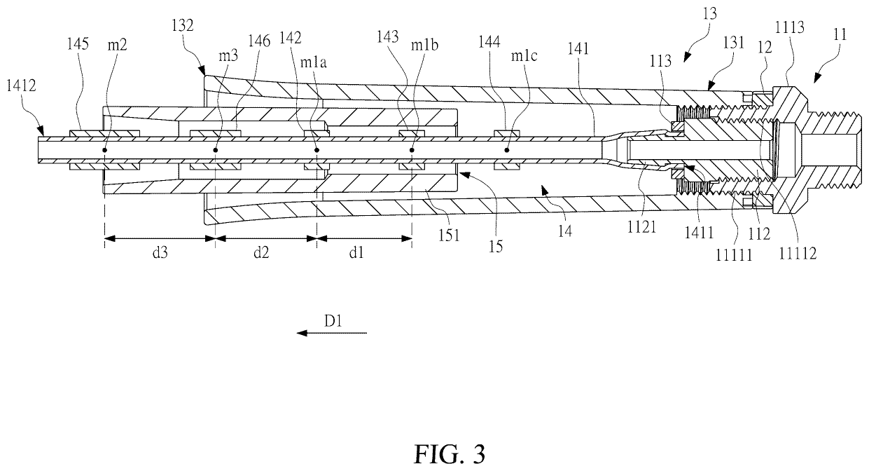

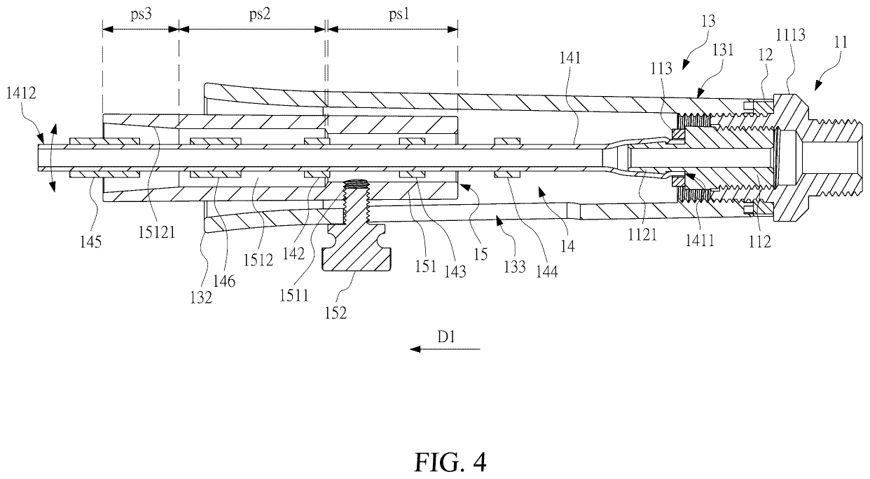

Please refer to FIGS. 1 to 4, the FIG. 1 illustrates a three-dimensional schematic diagram of the sprinkler provided by the first preferred embodiment of the present invention. The FIG. 2 is a three-dimensional exploded schematic diagram illustrating the sprinkler provided by the first preferred embodiment of the present invention. The FIG. 3 is a schematic diagram of the A-A section of the FIG. 1. The FIG. 4 is a schematic diagram of the B-B section of the FIG. 1.

As shown in FIGS. 1 to 4, a sprinkler 1 includes an adapter pipe assembly 11, an outer pipe position adjustment ring 12, a fixed outer pipe 13, a spray pipe 14 and a swing amplitude adjustment assembly 15.

The adapter pipe assembly 11 includes an outer pipe assembly 111, a hose assembly 112 and a clamp 113. The outer pipe assembly 111 has a first assembly end portion 1111 and a second assembly end portion 1112 that are connected to each other. The outer pipe assembly 111 also has an assembly pipe body part 1113, and the assembly pipe body part 1113 is located between the first assembly end portion 1111 and the second assembly end portion 1112, wherein the first assembly end portion 1111 has an outer thread 11111 and an inner thread 11112 arranged oppositely inside and outside.

The hose assembly 112 is screwed to the inner thread 11112 and is connected to the second assembly end portion 1112, and the hose assembly 112 has an extension pipe body 1121, and the extension pipe body 1121 extends along the telescopic direction D1. The clamp 113 is used to fix the spray pipe 14 to the extension pipe body 1121, wherein, in this embodiment, the clamp 113 is a C-type pipe clamp.

The outer pipe position adjustment ring 12 is screwed to the outer thread 11111 and is movably assembled to the first assembly end portion 1111 along a telescopic direction D1, wherein since in this embodiment, the outer pipe position adjustment ring 12 is screwed to the outer thread 11111, the outer pipe position adjustment ring 12 moves in the telescopic direction D1 by rotating to adjust the position.

The fixed outer pipe 13 includes a fixed end 131 and an open end 132 of the outer pipe arranged oppositely. The fixed end 131 of the outer pipe is screwed to the outer thread 11111, so that the fixed outer pipe 13 is fixed to the adapter pipe assembly 11, and the open end 132 is a gradually expanding trumpet-shaped opening. In addition, the fixed outer pipe 13 also has a stroke limiting hole 133 extending along the telescopic direction D1 between the fixed end 131 and the open end 132 of the outer pipe.

The spray pipe 14 includes an elastic pipe body 141, three in-pipe weight blocks 142, 143 and 144, an end weight block 145 and a buffer weight block 146.

The elastic pipe body 141 has an assembly end 1411 and a spray end 1412 arranged oppositely. The assembly end 1411 is inside the fixed outer pipe 13 and fixed to the extension pipe body 1121. In this embodiment, the assembly end 1411 of the elastic pipe body 141 is sleeved on the extension pipe body 1121 and is clamped and fixed by the above-mentioned clamp 113, thereby being sleeved and fixed on the extension pipe body 1121. The spray end 1412 extends from the assembly end 1411 along the telescopic direction D1 to the outside of the open end 132 of the fixed outer pipe 13.

Three in-pipe weight blocks 142, 143 and 144 are spaced apart from each other in the fixed outer pipe 13, sleeved and fixed on the elastic pipe body 141, and adjacent to the assembly end 1411, wherein the weight blocks 142, 143 and 144 inside the pipe each have a first weight, so that the weight blocks 142, 143 and 144 in the pipe have a first center of gravity m1a, m1b and m1c respectively. There is a first distance d1 between any adjacent two of the three first centers of gravity m1a, m1b and m1c (only one is marked in the figure). In this embodiment, when the materials and dimensions (such as diameter, length, and thickness) of the three in-pipe weight blocks 142, 143, and 144 are the same, the three in-pipe weight blocks 142, 143 and 144 are spaced apart from each other in the fixed outer pipe 13, and sleeved and fixed on the elastic pipe body 141.

The end weight block 145 is sleeved and fixed on the elastic pipe body 141 at the open end 132, and is adjacent to the spray end 1412. The end weight block 145 has a second weight greater than the first weight.

The buffer weight block 146 is sleeved and fixed on the elastic pipe body 141, and is located between one of the three in-pipe weights 142, 143 and 144 adjacent to the spray end 1412 (in this embodiment, it is the in-pipe weight block 142) and the end weight 145. The buffer weight block 146 has a third weight, and the third weight is greater than the first weight and less than the second weight. In addition, the end weight block 145 has a second center of gravity m2, and the buffer weight block 146 has a third center of gravity m3. There is a second distance d2 between the third center of gravity m3 and the first center of gravity m1a of the weight block 142 in the pipe, and there is a third distance d3 between the second center of gravity m2 and the third center of gravity m3, wherein the second distance d2 is greater than the third distance d3 and smaller than the first distance d1, so that the center of gravity of the entire spray pipe 14 changes gradually in the extension and contraction direction D1

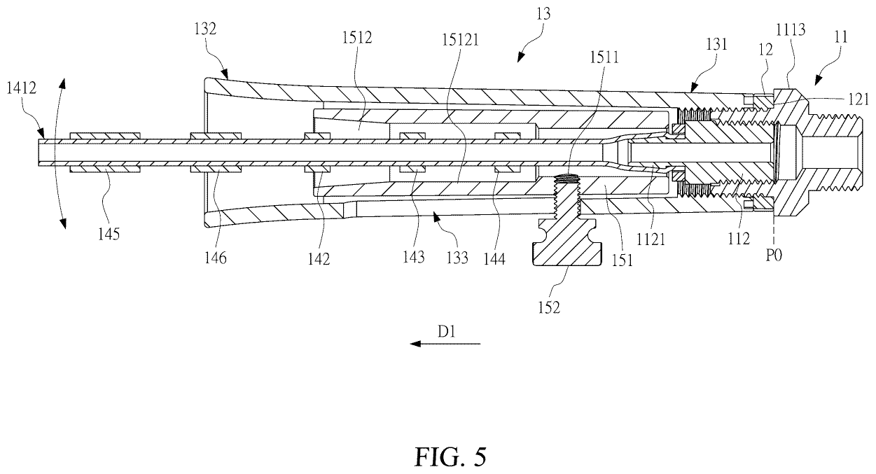

Referring to the FIG. 5, the FIG. 5 is a schematic cross-sectional view illustrating the swing adjustment pipe moving to the minimum limit position in the first preferred embodiment of the present invention. As shown in the FIGS. 4 and 5, the swing amplitude adjustment assembly 15 includes a swing adjustment pipe 151 and a locking piece 152. The swing adjustment pipe 151 is movably arranged in the fixed outer pipe 13 along the telescopic direction D1 and is sleeved on the spray pipe 14, and the swing adjustment pipe 151 has a lock hole 1511 and an adjustment pipe channel 1512. The lock hole 1511 corresponds to the stroke limiting hole 133. The adjustment pipe channel 1512 has a first connected section ps1, a second connected section ps2 and a third connected section ps3 in sequence along the telescopic direction D1.

The first connected section ps1 extends along the telescopic direction D1 and has a first pipe diameter (not shown in the figure), and the first pipe diameter is larger than the in-pipe weight blocks 142, 143 and 144, the end weight block 145. and the diameter of the buffer weight block 146. In addition, the keyhole 1511 penetrates the pipe wall of the first connected section ps1 along the radial direction perpendicular to the telescopic direction D1 and is connected to the adjustment pipe channel 1512

The second connected section ps2 is connected to the first connected section ps1 and has a second pipe diameter larger than the first pipe diameter (not shown in the figure).

The third connected section ps3 is connected to the second connected section ps2, and has a tapered inner wall 15121 that gradually expands along the telescopic direction D1. That is, the change in pipe diameter of the tapered inner wall 15121 starts from the second pipe diameter of the connected second connected section ps2 and increases gradually, wherein the spray pipe 14 passes through the adjustment pipe channel 1512.

The locking piece 152 is movably inserted through the stroke limiting hole 133 along the telescopic direction D1 and is screwed to the lock hole 1511 to selectively fix the position of the swing adjustment pipe 151 in the fixed outer pipe 13 to adjust the swing amplitude of the spray pipe 14. For example, as shown in the FIG. 4, when the locking piece 152 moves in the stroke limiting hole 133 to adjacent to the open end 132, the swing adjustment pipe 151 will be driven to cover almost the entire spray pipe 14, and only the spray end 1412 and half of the end weight block 145 are exposed from the swing adjustment pipe 151. Therefore, when the spray pipe 14 swings, the third connected section ps3 will limit the range of movement of the end weight block 145 and make the swing amplitude of the entire spray pipe 14 smaller. On the contrary, as shown in the FIG. 5, when the locking piece 152 moves in the stroke limiting hole 133 away from the opening end 132, the swing adjustment pipe 151 will be driven to almost only cover the in-pipe weight blocks 142, 143 and 144, so that the spray end 1412, the end weight block 145 and the buffer weight block 146 are all exposed outside the swing adjustment pipe 151. Therefore, when the spray pipe 14 swings, the end weight block 145 and the buffer weight block 146 can move outside the swing adjustment pipe 151, thereby allowing the entire spray pipe 14 to have a larger swing range.

It should be noted that since the spray pipe 14 is installed in the swing adjustment pipe 151, the thickness of the inner weight block 142, the end weight block 145 and the buffer weight block 146 are all the same, and they only differ in length. Therefore, when the materials are the same, the inner weight block 142, the end weight block 145 and the buffer weight block 146 can have different weights due to different lengths. But it is not limited to this. In other embodiments, the in-pipe weight block 142, the end weight block 145 and the buffer weight block 146 can also have the same size, but use different materials to adjust the weight, or even have the same size and material, and adjust the weight through different density

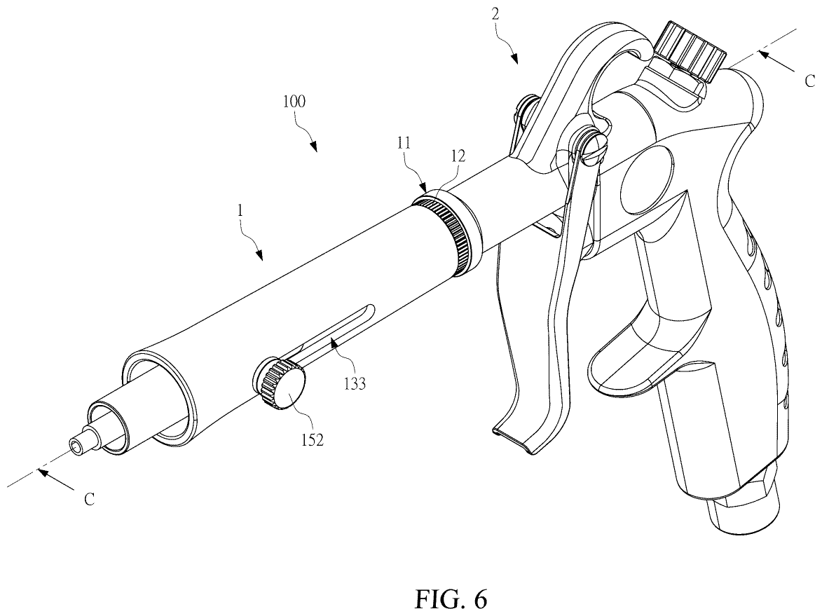

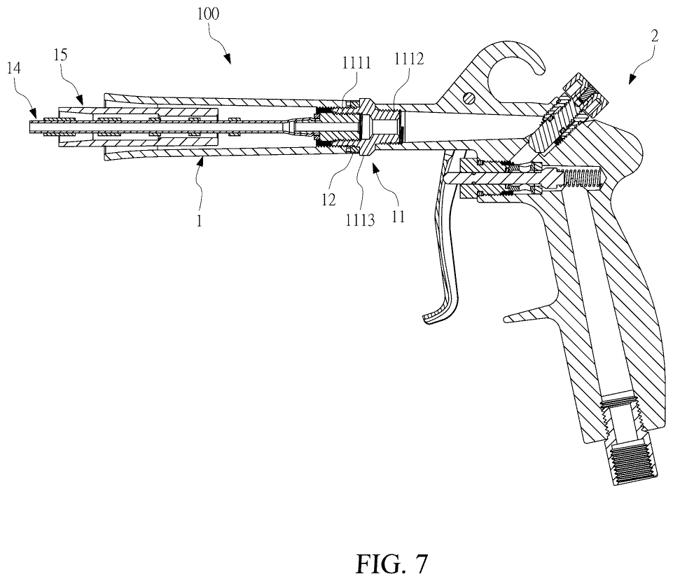

Referring to the FIGS. 6 and 7, the FIG. 6 is a three-dimensional schematic diagram illustrating the swing-type spray cleaning gun provided by the second preferred embodiment of the present invention, and the FIG. 7 is a schematic diagram of the C-C section of the FIG. 6. As shown in the FIGS. 1 to 7, a swing-type spray cleaning gun 100 includes a gas supplier 2 and the above-mentioned sprinkler 1.

The gas supplier 2 is used to provide a high-pressure gas, wherein the gas supplier 2 in this embodiment is a spray gun handle that can be connected to an external high-pressure gas supply source so that the high-pressure gas provided by the high-pressure gas supply source can enter the internal gas supply pipeline. The spray gun handle also has a push switch that can control the opening or closing of the gas supply line.

As mentioned in the above, in this embodiment, the above-mentioned sprinkler 1 is connected to the gas supplier 2 through the second assembly end portion 1112 of the adapter pipe assembly 11. Thereby, when the user operates the push switch of the gas supplier 2, the high-pressure gas can be controlled to enter the adapter pipe assembly 11 through the gas supply pipeline of the gas supplier 2, and be sprayed out from the spray pipe 14. When the high-pressure gas is ejected from the spray pipe 14, the elastic pipe body 141 is equipped with an end weight block 145 on the spray end 1412, so that the spray end 1412 swings in a ring shape with the centrifugal force formed by the weight block 145. The arrangement of the weight blocks 142, 143 and 144, the buffer weight block 145 and the buffer weight block 146 in the pipe also improves the swing stability of the elastic pipe body 141.

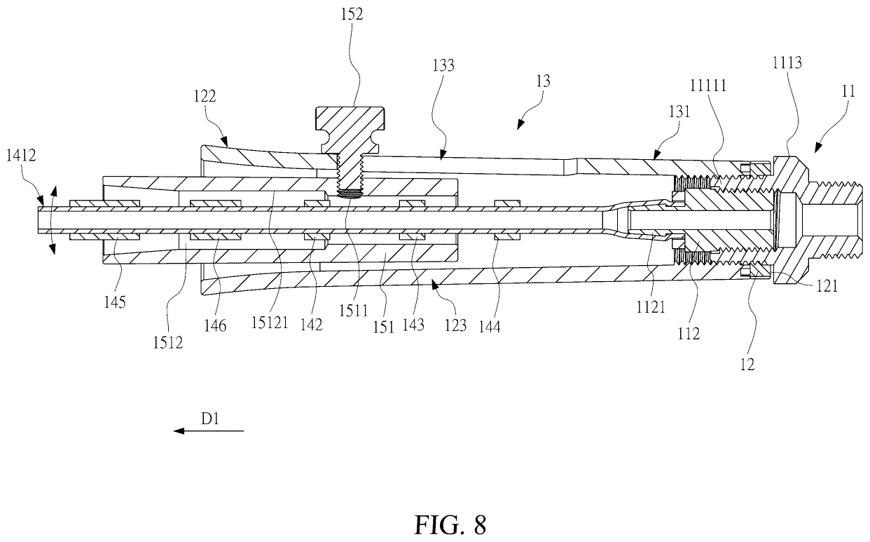

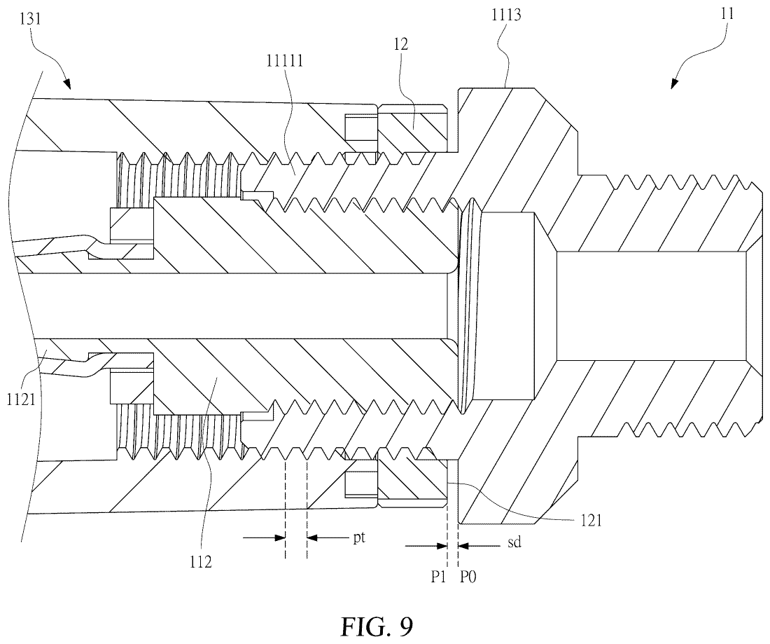

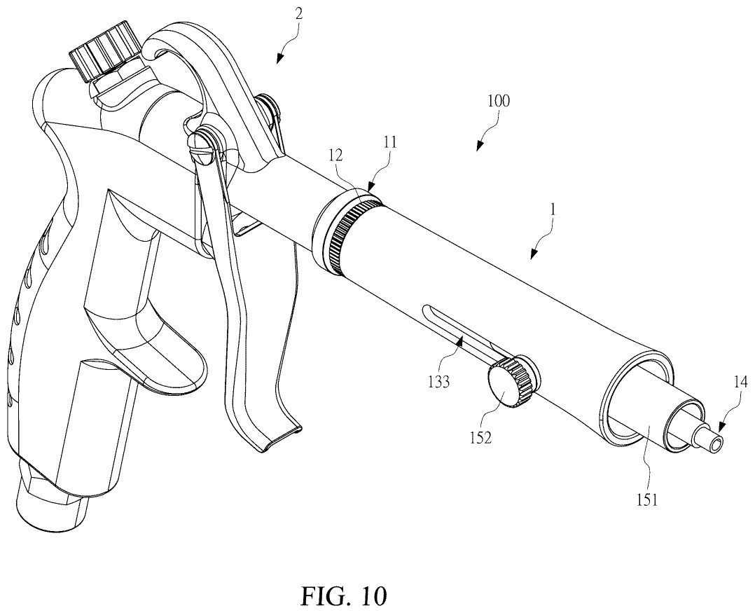

Referring to the FIGS. 8 to 10, the FIG. 8 is a schematic cross-sectional view to illustrate the sprinkler provided by the second preferred embodiment of the present invention adjusts the position of the fixed outer pipe by changing the position of the outer pipe position adjustment ring. The FIG. 9 is a partially enlarged diagram of the FIG. 8. FIG. 10 is a schematic three-dimensional view of the swing-type spray cleaning gun provided by the second preferred embodiment of the present invention

As shown in FIGS. 1 to 10, since the sprinkler 1 of this embodiment is provided with an outer pipe position adjustment ring 12 to adjust the relative position of the fixed outer pipe 13 screwed to the outer thread 11111, therefore, the user can adjust the fixed position of the fixed outer pipe 131 by changing the position of the outer pipe position adjustment ring 12 screwed to the outer thread 11111.

For example, when the outer pipe position adjustment ring 12 is rotated to the bottom along the outer thread 11111 towards the assembly pipe body part 1113, the outer pipe position adjustment ring 12 will move in the opposite direction of the telescopic direction D1, and one end surface 121 of the outer pipe position adjustment ring 12 moves to an adjustment position P0 that is in contact with the main body portion 1113 of the assembly pipe. At this time, when the fixed outer pipe 13 is rotated to the bottom along the outer thread 11111, and is in contact with the outer pipe position adjustment ring 12, the stroke limiting hole 133 of the fixed outer pipe 13 will be located on the left side as shown in the FIG. 6 (from the perspective of the gas supplier 2 facing the sprinkler 1).

As mentioned in the above, when the user needs to adjust the position of the stroke limiting hole 133 of the fixed outer pipe 13, the user can first rotate the outer pipe position adjustment ring 12 along the outer thread 11111. The end face 121 moves from the adjustment position P0 toward the telescopic direction D1 by an adjustment distance sb to another adjustment position P1, so that the relative position of the fixed outer pipe 13 screwed to the outer thread 11111 is adjusted, thereby changing the arrangement orientation of the stroke limiting hole 133.

In this embodiment, the above-mentioned adjustment distance sb is half the pitch pt of the outer thread 11111. Therefore, compared with the outer tube position adjustment ring 12 with the end face 121 at the adjustment position P0, the outer tube position adjustment ring 12 with the end face 121 at the adjustment position P1 will cause the fixed outer pipe 13 to rotate half a turn, so that the stroke limiting hole 133 is located on the right side as shown in FIG. 10 (from the perspective of the gas supplier 2 facing the sprinkler 1).

In addition, in other embodiments, the user can also adjust the position of the stroke limiting hole 133 of the fixed outer pipe 13 to be above or below by changing the position of the outer pipe position adjustment ring 12 that is screwed to the outer thread 11111.

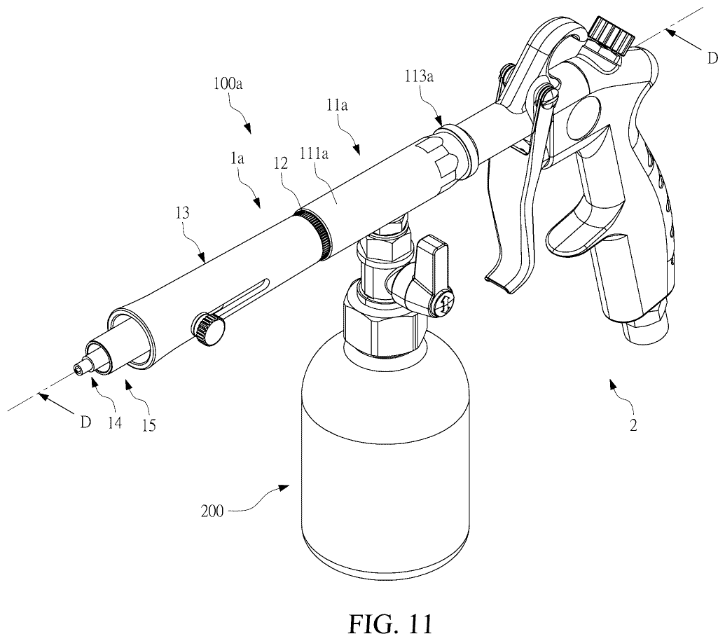

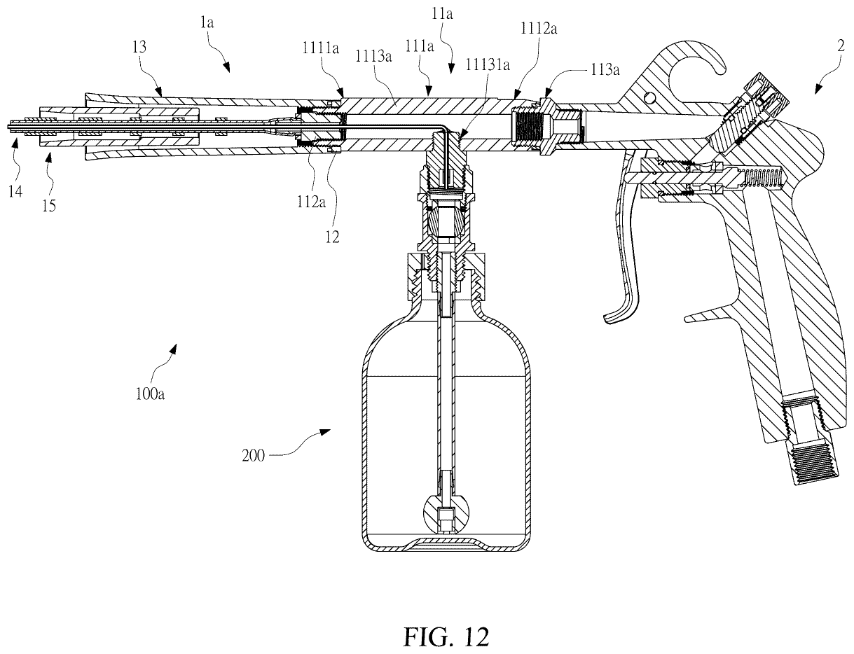

Referring to FIGS. 11 and 12, the FIG. 11 is a three-dimensional schematic diagram illustrating the swing-type spray cleaning gun provided by the third preferred embodiment of the present invention and the FIG. 12 is a schematic diagram of the D-D section of the FIG. 11. As shown in FIGS. 1 to 12, a swing-type spray cleaning gun 100a includes the above-mentioned gas supplier 2 and a sprinkler 1a. wherein the sprinkler 1a is similar to the above-mentioned sprinkler 1. The main difference is that the sprinkler 1a uses an adapter pipe assembly 11a to replace the above-mentioned adapter pipe assembly 11.

As mentioned in the above, the adapter pipe assembly 11a includes an outer pipe assembly 111a, a hose assembly 112a and a supplier assembly 113a, wherein the first assembly end portion 1111 has an outer thread 11111 and an inner thread 11112 arranged oppositely inside and outside. The outer pipe assembly 111a has a first assembly end portion 1111a and a second assembly end portion 1112a that are connected to each other, and has the assembly body part 1113a located between the first assembly end portion 1111a and a second assembly end portion 1112a. The first assembly end portion 1111a has an outer thread (not shown in the figure, similar to the above-mentioned outer thread 11111) and an inner thread (not shown in the figure, similar to the above-mentioned inner thread 11112) arranged oppositely inside and outside. The fixed outer tube 13 is screwed to the outer thread, and the hose assembly 112a is screwed to the inner thread, wherein the hose assembly 112a is similar to the above-mentioned hose assembly 112, so it will not be described in detail here.

In addition, the assembly joint body part 1113a also has an additional assembly hole 11131a. The additional assembly hole 11131a is used to assemble a liquid supply module 200, and the liquid supply module 200 is an existing assembly. When the liquid supply module 200 is combined with the gas supplier 2, the entire swing-type spray cleaning gun 100a can be used for spraying liquid, and the liquid provided by the liquid supply module 200 can be water or cleaning liquid.

The supplier assembly 113a is assembled to the second assembly end portion 1112 and is used to be assembled to the gas supplier 2. Therefore, in this embodiment, the liquid supply module 200 is mainly assembled through the additional assembly hole 11131a of the outer pipe assembly 111a. Since one of the infusion pipes (not shown in the figure) of the liquid supply module 200 is exposed from the spray pipe 14, therefore, when the high-pressure gas provided by the gas supplier 2 is ejected from the spray pipe 14, it will not only drive the spray pipe 14 to swing around, but also drive the liquid in the liquid supply module 200 to eject from the infusion pipe due to the Wen-type effect, thus resulting in a uniform and wide range of liquid spraying range.

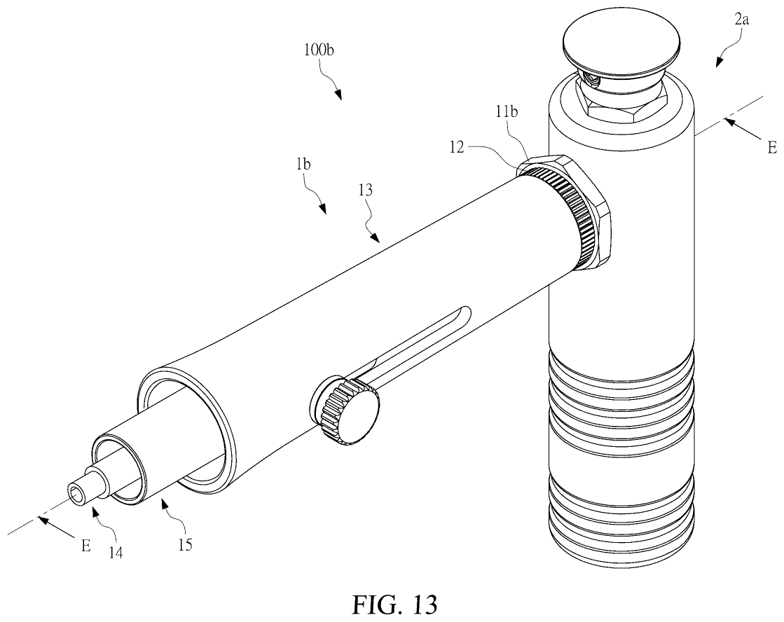

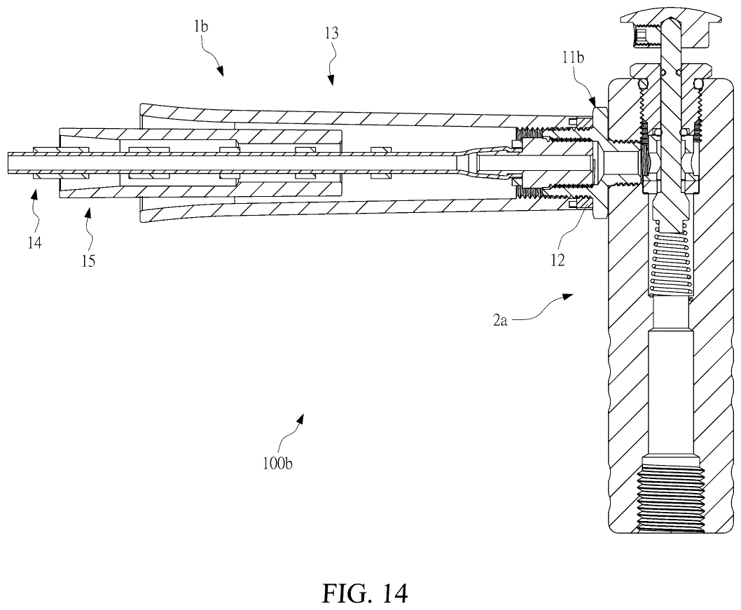

Referring to FIGS. 13 and 14, the FIG. 13 is a three-dimensional schematic diagram illustrating the swing-type spray cleaning gun provided by the fourth preferred embodiment of the present invention and the FIG. 14 is a schematic diagram of the E-E section of FIG. 13. As shown in FIGS. 1 to 5 and FIGS. 13 and 14, a swing-type spray cleaning gun 100b includes a gas supplier 2a and a sprinkler 1b, wherein the sprinkler 1b is similar to the above-mentioned sprinkler 1, and the main difference is that the sprinkler 1b uses an adapter pipe assembly 11b to replace the above-mentioned adapter pipe assembly 11. The functions of the adapter pipe assembly 11b and the adapter pipe assembly 11 are exactly the same. They are only slightly different in appearance, so they will not be described in detail here.

The gas supplier 2a is similar to the above-mentioned gas supplier 2, and the only difference is that the gas supplier 2a is a vertical pressing type spray gun handle, so no further details will be given here.

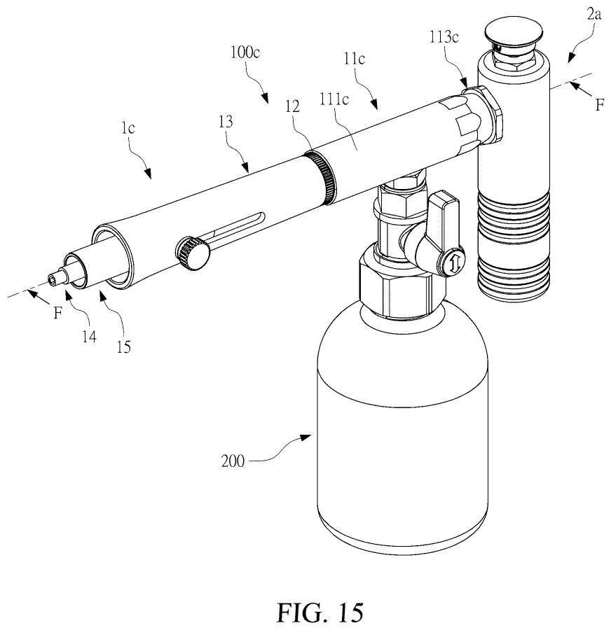

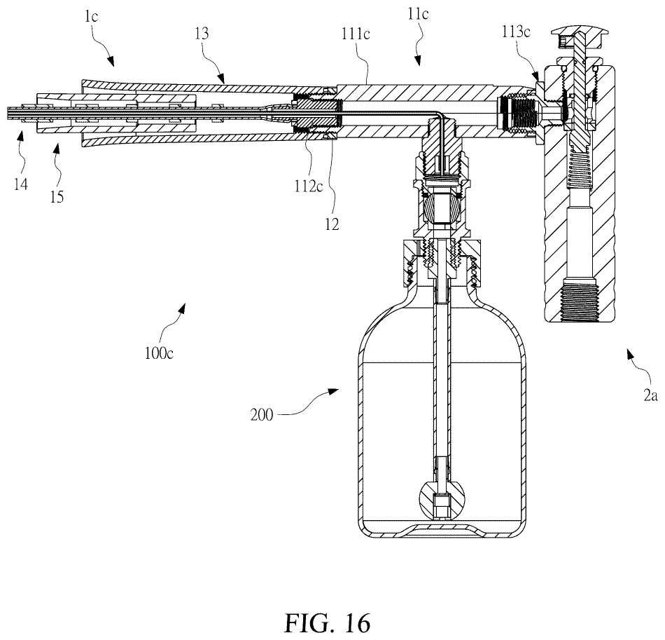

Referring to FIGS. 15 and 16, the FIG. 15 is a three-dimensional schematic diagram illustrating the swing-type spray cleaning gun provided by the fifth preferred embodiment of the present invention and the FIG. 16 is a schematic diagram of the F-F section in FIG. 15. As shown in FIGS. 1 to 16, a swing-type spray cleaning gun 100c includes the above-mentioned gas supplier 2a and a sprinkler 1c, wherein the sprinkler 1c is similar to the above-mentioned sprinkler 1a, and the main difference is that the sprinkler 1c uses an adapter pipe assembly 11c to replace the above-mentioned adapter pipe assembly 11a. The adapter pipe assembly 11c includes an outer pipe assembly 111c, a hose assembly 112c and a supplier assembly 113c. The structures of the outer pipe assembly 111c and the hose assembly 112c are the same as those of the outer pipe assembly 111a and the hose assembly 112a respectively, and the function of the supplier assembly part 113c is the same as that of the supplier assembly part 113a and they are only slightly different in shape. To put it simply, compared with the above-mentioned swing-type spray cleaning gun 100b, the swing-type spray cleaning gun 100c mainly uses the adapter pipe assembly 11c to assemble the liquid supply module 200.

To sum up, the swing-type spray cleaning gun and sprinkler provided by this invention mainly consists of a plurality of pipe weight blocks and an end weight block respectively arranged at the assembly end and spray end of the elastic pipe body. By using smaller centrifugal force provided by the smaller weight blocks inside the fixed outer pipe, and using greater centrifugal force provided by the heavier end weight block outside the fixed outer pipe, providing greater centrifugal force, the center of gravity of the entire spray pipe changes relatively evenly. Compared with the hoses of the prior art, which only have a weight block at the outlet end, resulting in a top-heavy and uneven center of gravity problem, this invention can indeed increase the centrifugal force of the spray pipe gradually and evenly from the inside out by using the weight blocks inside the pipe and the end weight block, effectively improving the stability of the spray pipe when it swings around.

As mentioned in the above, this invention is also provided with a buffer weight block with a weight between the weight block inside the pipe and the end weight block, and the distance between the center of gravity of the buffer weight and the two also gradually lengthens as the overall weight changes. The weight distribution of the entire spray pipe increases with the swing amplitude, which is more helpful to improve the stability of the spray pipe when swinging.

While the present invention has been particularly shown and described with reference to a preferred embodiment, it will be understood by those skilled in the art that various changes in form and detail may be without departing from the spirit and scope of the present invention.

What is claimed is:

1. A swing-type spray cleaning gun, comprising:
a gas supplier for providing a high-pressure gas; and
a sprinkler, comprising:
an adapter pipe assembly fixedly connected to the gas supplier and connected to a gas supply pipeline of the gas supplier;
a fixed outer pipe fixedly connected to the adapter pipe assembly, connected to the gas supply pipeline, and having a stroke limiting hole extending along a telescopic direction;
a spray pipe, comprising:
an elastic pipe body having an assembly end and a spray end arranged oppositely, wherein the assembly end is fixed to the adapter pipe assembly in the fixed outer pipe and connected to the gas supply pipeline, and the spray end extends from the assembly end to the outside of an open end of the fixed outer pipe;
a plurality of in-pipe weight blocks spaced apart from each other in the fixed outer pipe, and sleeved and fixed to the elastic pipe body, and adjacent to the assembly end, and each of the in-pipe weight blocks having a first weigh; and
an end weight block sleeved and fixed on the elastic pipe body at the open end, and adjacent to the spray end, and the end weight block having a second weight greater than the first weight; and
a swing amplitude adjustment assembly, comprising:
a swing adjustment pipe movably arranged in the fixed outer pipe along the telescopic direction, and sleeved on the spray pipe; and
a locking piece is movably inserted into the stroke limiting hole along the telescopic direction to selectively fix the position of the swing adjustment pipe in the fixed outer pipe, thereby adjusting the swing amplitude of the spray pipe.

2. The swing-type spray cleaning gun of claim 1, wherein the spray pipe further comprises a buffer weight, the buffer weight block is sleeved and fixed on the elastic pipe body, and is located between one of the in-pipe weight blocks adjacent to the spray end and the end weight block, and the buffer weight block has a third weight, which is greater than the first weight and less than the second weight.

3. The swing-type spray cleaning gun of claim 2, wherein each of the in-pipe weight blocks has a first center of gravity, the end weight block has a second center of gravity, the buffer weight block has a third center of gravity, first centers of gravity have a first distance from each other, a second distance is between the third center of gravity and the first center of gravity of one of the in-pipe weight blocks adjacent to the spray end, a third distance is between the second center of gravity and the third center of weight, and the second distance is greater than the third distance and smaller than the first distance.

4. The swing-type spray cleaning gun of claim 1, wherein the adapter pipe assembly comprises:
an outer pipe assembly having a first assembly end portion and a second assembly end portion connected to each other, wherein the first assembly end portion has an outer thread and an inner thread oppositely arranged, the fixed outer pipe is screwed to the outer thread, and the second assembly end portion is fixed to the gas supplier and connected to the gas supply pipeline; and
a hose assembly screwed to the inner thread, connected to the second assembly end portion, and having an extension tube body, wherein the elastic tube body is sleeved and fixed to the extension tube body, and is connected to the gas supply pipeline through the outer pipe assembly and the hose assembly.

5. The swing-type spray cleaning gun of claim 1, wherein the adapter pipe assembly comprises:
an outer pipe assembly having a first assembly end portion and a second assembly end portion connected to each other, wherein the first assembly end portion has an outer thread and an inner thread oppositely arranged, the fixed outer pipe is screwed to the outer thread, the outer pipe assembly further has an additional assembly hole between the first assembly end portion and the second assembly end portion, and the additional assembly hole is used to assemble a liquid supply module;
a hose assembly screwed to the inner thread, connected to the second assembly end portion, and having an extended pipe body, wherein the elastic pipe body is sleeved and fixed to the extension pipe body, and is connected to the gas supply pipeline through the outer pipe assembly and the hose assembly; and
a supplier assembly, wherein the supplier assembly is assembled to the second assembly end portion and used to be assembled to the gas supplier, so that the outer pipe assembly is connected to the gas supply pipeline.

6. The swing-type spray cleaning gun of claim 1, wherein the sprinkler further comprises an outer pipe position adjustment ring, the outer pipe position adjustment ring is movably assembled to the adapter pipe assembly along the telescopic direction, and is located between the adapter pipe assembly and the fixed outer pipe, for adjusting the position where the fixed outer pipe is fixed to the adapter pipe assembly.

7. A sprinkler used in conjunction with a gas supplier, comprising:
an adapter pipe assembly fixedly connected to the gas supplier and connected to a gas supply pipeline of the gas supplier;
a fixed outer pipe fixedly connected to the adapter pipe assembly, connected to the gas supply pipeline, and having a stroke limiting hole extending along a telescopic direction;
a spray pipe, comprising:
an elastic pipe body having an assembly end and a spray end arranged oppositely, wherein the assembly end is fixed to the adapter pipe assembly in the fixed outer pipe and connected to the gas supply pipeline, and the spray end extends from the assembly end to the outside of an open end of the fixed outer pipe;
a plurality of in-pipe weight blocks spaced apart from each other in the fixed outer pipe, and sleeved and fixed to the elastic pipe body, and adjacent to the assembly end, and each of the in-pipe weight blocks having a first weigh; and
an end weight block sleeved and fixed on the elastic pipe body at the open end, and adjacent to the spray end, and the end weight block having a second weight greater than the first weight; and
a swing amplitude adjustment assembly, comprising:
a swing adjustment pipe movably arranged in the fixed outer pipe along the telescopic direction, and sleeved on the spray pipe; and
a locking piece is movably inserted into the stroke limiting hole along the telescopic direction to selectively fix the position of the swing adjustment pipe in the fixed outer pipe, thereby adjusting the swing amplitude of the spray pipe.

8. The sprinkler of claim 7, wherein each of the in-pipe weight blocks has a first center of gravity, the end weight block has a second center of gravity, the buffer weight block has a third center of gravity, first centers of gravity have a first distance from each other, a second distance is between the third center of gravity and the first center of gravity of one of the in-pipe weight blocks adjacent to the spray end, a third distance is between the second center of gravity and the third center of weight, and the second distance is greater than the third distance and smaller than the first distance.

9. The sprinkler of claim 8, wherein the in-pipe weight blocks have a first distance from each other, a second distance is between the buffer weight block and one of the in-pipe weight blocks adjacent to the spray end, a third distance is between the end weight block and the buffer weight block, and the second distance is greater than the third distance and smaller than the first distance.

10. The sprinkler of claim 7, wherein the adapter pipe assembly comprises:
an outer pipe assembly having a first assembly end portion and a second assembly end portion connected to each other, wherein the first assembly end portion has an outer thread and an inner thread oppositely arranged, the fixed outer pipe is screwed to the outer thread, and the second assembly end portion is fixed to the gas supplier and connected to the gas supply pipeline; and
a hose assembly screwed to the inner thread, connected to the second assembly end portion, and having an extension tube body, wherein the elastic tube body is sleeved and fixed to the extension tube body, and is connected to the gas supply pipeline through the outer pipe assembly and the hose assembly.

11. The sprinkler of claim 7, wherein the adapter pipe assembly comprises:
an outer pipe assembly having a first assembly end portion and a second assembly end portion connected to each other, wherein the first assembly end portion has an outer thread and an inner thread oppositely arranged, the fixed outer pipe is screwed to the outer thread, the outer pipe assembly further has an additional assembly hole between the first assembly end portion and the second assembly end portion, and the additional assembly hole is used to assemble a liquid supply module;
a hose assembly screwed to the inner thread, connected to the second assembly end portion, and having an extended pipe body, wherein the elastic pipe body is sleeved and fixed to the extension pipe body, and is connected to the gas supply pipeline through the outer pipe assembly and the hose assembly; and
a supplier assembly, wherein the supplier assembly is assembled to the second assembly end portion and used to be assembled to the gas supplier, so that the outer pipe assembly is connected to the gas supply pipeline.

12. The sprinkler of claim 7, wherein the sprinkler further comprises an outer pipe position adjustment ring, the outer pipe position adjustment ring is movably assembled to the adapter pipe assembly along the telescopic direction, and is located between the adapter pipe assembly and the fixed outer pipe, for adjusting the position where the fixed outer pipe is fixed to the adapter pipe assembly.
